(19) United States
(12) Patent Application Publication
(10) Pub. No.: US 2024/0160460 A1
(43) Pub. Date: May 16, 2024

(54) SYSTEMS AND METHODS PROVIDING AUTOMATED FAILURE RESOLUTION IN VIRTUAL MACHINES

(71) Applicant: BANK OF AMERICA CORPORATION, Charlotte, NC (US)

(72) Inventors: Prabhat Ranjan, Plano, TX (US); Christopher Herman Cokis, Raleigh, NC (US); Karan Singh Negi, Mumbai (IN); Sean Edward Melvin, Indian Trail, NC (US); Shilpa Banerjee, Charlotte, NC (US)

(73) Assignee: BANK OF AMERICA CORPORATION, Charlotte, NC (US)

(21) Appl. No.: 17/986,416

(22) Filed: Nov. 14, 2022

(51) Int. Cl. G06F 9/455

(52) U.S. Cl. CPC G06F 9/45558; G06F 2009/45591

(57) ABSTRACT

Systems, computer program products, and methods are described herein for automated failure resolution in virtual machines. The present disclosure is configured to provide a one-click restart automation across both lower and production environments for various virtual machines. This leads to consistent and predictable virtual machine outages and leverages a secure application programming interface service for reliable, automated virtual machine health validation. The process is standardized, centralized, and updatable or upgradable over time. In addition, the process is also transparent, in that success or failure reporting with error codes is provided via detailed notification processing architecture.

### TECHNOLOGICAL FIELD

Example embodiments of the present disclosure relate to automation and streamlining of processes for determining virtual machine failures, as well as locating and implementing specific solutions to such failures.

### BACKGROUND

In certain data or process management software, the introduction of embedded queue processing and real time data streaming has introduced various issues with operational restart of applications during release or recovery testing. Using conventional approaches, applications may take multiple hours for successful manual restart. This has introduced negative outcomes to systems which rely on real-time data delivery and overall application availability.

As such, applicant has identified a number of deficiencies and problems associated with conventional approaches to determining and remedying virtual machine failures. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for automated failure resolution in virtual machines. The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

The system may include at least one non-transitory storage device and at least one processing device coupled to the at least one non-transitory storage device, where the at least one processing device may be configured to ping one or more virtual machines of a data management platform to request a status of operation of the one or more virtual machines; receive status data from the one or more virtual machines; apply a reusable script on the status data from the one or more virtual machines to generate a status notification; automatically route the status notification to one or more end-point devices; simultaneously, in conjunction with routing the status notification, publish HTML code representing the status data from the one or more virtual machines.

In some embodiments, status notification further comprises one or more error codes indicating specific issues with the one or more virtual machines, wherein the error codes comprise embedded links to the published HTML code representing the status data from the one or more virtual machines.

In some embodiments, pinging the one or more virtual machines of the data management platform further comprises using a representational state transfer (REST) application programming interface (API).

In some embodiments, the status data from the one or more virtual machines further comprises failure notifications including a host connect error, secure socket layer (SSL) connect error, monitor time out, virtual host error, internal server error, server not available error, stream node error, service registry error, or stale thread error.

In some embodiments, the invention is further configured to: schedule a shutdown of a subset of the one or more virtual machines, wherein scheduling the shutdown comprises utilizing a job scheduler to determine a sequential order of shutdowns for the subset of the one or more virtual machines based on virtual machine type and application size.

In some embodiments, the virtual machine type comprises a streaming virtual machine, batch group virtual machine, or user group virtual machine.

In some embodiments, the invention is configured to: schedule a startup of a subset of the one or more virtual machines, wherein scheduling the startup comprises utilizing a job scheduler to determine a sequential order of startups for the subset of the one or more virtual machines based on virtual machine type and application size.

The features, functions, and advantages that have been discussed may be achieved independently in various embodiments of the present invention or may be combined with yet other embodiments, further details of which may be seen with reference to the following description and drawings.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automated failure resolution in virtual machines, in accordance with an embodiment of the disclosure;

FIG. 2 illustrates a process flow for automated failure resolution in virtual machines, in accordance with an embodiment of the disclosure; and

FIG. 3 illustrates a process flow for automated failure resolution in virtual machines, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository—a storage location where one or more resources are organized, stored and retrieved electronically using a computing device.

Today there are many steps application developers must complete to deploy software within a large entity. There is a need for developing and deploying a framework for improving the process, such as by automating and simplifying the process of data capture, resolution, and dissemination. Examples of such software may include various customer relationship management (CRM) or business process management software, collectively referred to herein as a data management platform (e.g., Pega, or the like). Software of this nature provides for an adaptive, cloud-architected software that empowers users to rapidly deploy, and easily extend and change, applications to meet strategic business needs, providing capabilities in content and resource management and business process management (BPM). This software functions to automate the workflow of certain tasks, including building and delivering software or virtual machine availability.

In the current state of the art, there is a known issue with regard to reliability of Java virtual machines (JVMs) which are automated and managed in data management platforms. Specifically, data from workflows to downstream applications and consumers must be provided in a near-real-time fashion and must have significant uptime in order to meet the needs of large entities. Minimizing downtime and reducing the amount of time required to locate and fix issues related to data provisioning can save large entities resources and reduce the chance of negative reputational effect. Typically, applications either consume data directly from data management platforms in real-time, or data is shipped in a batch process to consumers and downstream applications. Based on a recent developments of the present invention, a number of functional requirements are determined to best develop a useful means to automate JVMs that manage modern data management platform applications. Specifically, the present solution allows for users to start and stop JVMs in the most efficient and reliable order based on the version of data management platform in use, requiring specific start and stop order logic. Additionally, the present invention includes validation that the data management platform application has started and is healthy, rather than relying on a JVM/WebSphere status as in conventional systems. Furthermore, the present invention includes schedulable processes, as well as a built-in means of notification or reporting of certain processes.

The present invention is intended to be appropriate across an entire entity framework that interact with data management platform software. However, if necessary, scripts can be developed in a team-specific manner for certain data flows. Startup order may vary based on version, topology of a particular application, whether services are externalized, or other unforeseen factors as a result of future data management platform updates that the entity may have no control over. As such, the approach of the present invention is modular, flexible and easy to configure based on varying environmental factors. The present invention also prioritizes easy onboarding of new users or applications with out the need for extensive setup processes. In this way, script execution should not be dependent on command line access to servers, and should allow for self-service options for developer and system integrations testing (SIT) environments.

Systems, computer program products, and methods are described herein for automated failure resolution in virtual machines. The present disclosure is configured to provide a one-click restart automation across both lower and production environments for various virtual machines. This leads to consistent and predictable virtual machine outages and leverages a secure application programming interface service for reliable, automated virtual machine health validation. The process is standardized, centralized, and updatable or upgradable over time. In addition, the process is also transparent, in that success or failure reporting with error codes is provided via detailed notification processing architecture.

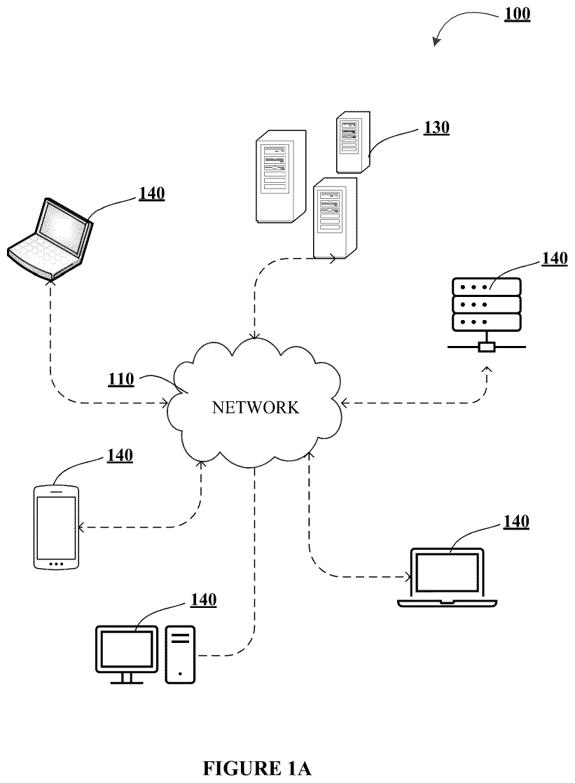

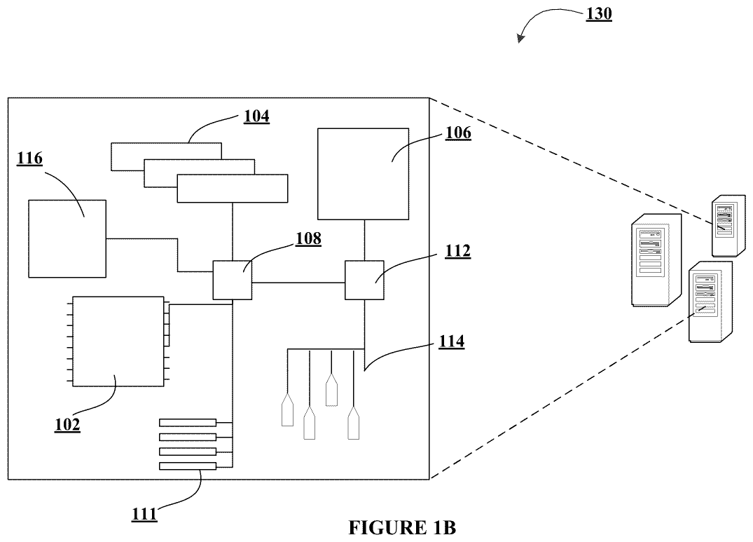

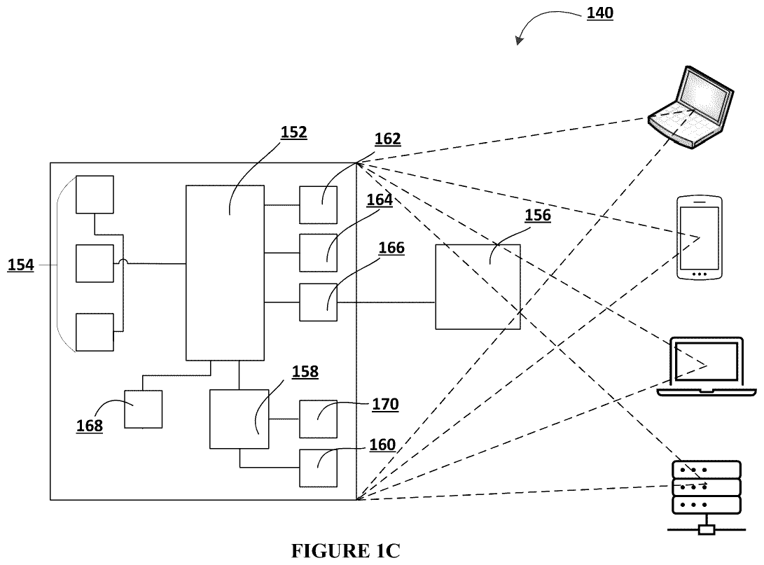

FIGS. 1A-1C illustrate technical components of an exemplary distributed computing environment for automated failure resolution in virtual machines 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

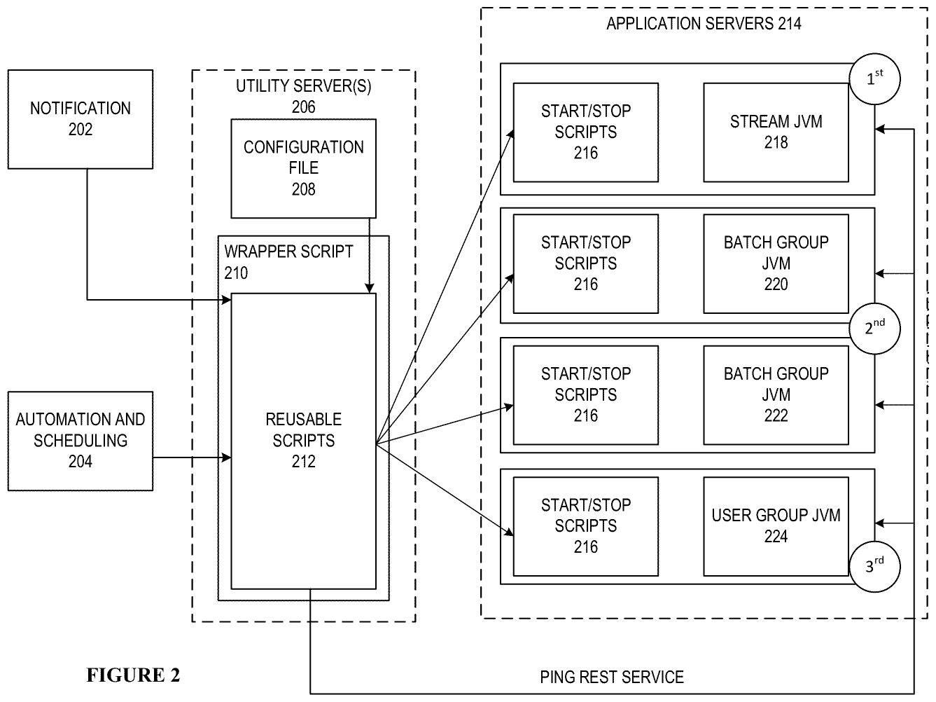

FIG. 2 illustrates a process flow for automated failure resolution in virtual machines, in accordance with an embodiment of the disclosure. As shown, the process of FIG. 2 begins whereby a notification 202 is received by the system indicating a status of one or more JVMs. For instance, when a job, such as either shutdown or startup, is initiated, an email may be distributed indicting that the application or environment action is in progress, such as a “job initiation” message, or the like. In other embodiments, the notification may include a “job complete” message (e.g., job completed with no errors, or the like). Following job-completion, one or more additional notifications may be sent. A second notification may provide an additional table that includes a summary state. Furthermore, a notification may include “job complete (with errors),” or the like, which indicates that one or more JVMs are in an unhealthy state. In this instance, a status report message will provide error codes that link to published HTML pages that provide error definitions and potential solution actions. In some embodiments, a validation process will occur again (e.g., every 15 minutes, or the like), until all JVMs are in a healthy and functioning state, via automation and scheduling engine 204.

It is understood that the utility server(s) 206 may comprise a configuration file 208, a wrapper script 210 (e.g., a shell script that embeds a system command or utility, that accepts and passes a set of parameters to that command, or the like), and one or more reusable scripts 212 (e.g., scripts that can be referenced by multiple maps or processes, or the like). In this way, the utility server(s) 206 may ping, using a representational state transfer (REST) application programming interface (API) service, one or more application servers 214 in order to determine the status of various JVMs. It is understood that various start/stop scripts 216 shown in FIG. 2 interface with the utility server(s) 206 via an encrypted secure shell (SSH) communication framework. As shown in FIG. 2, various JVMs may include stream JVM 218, one or more batch group JVMs 220 and 222, as well as user group JVMs 224.

The ping REST service performs a series of tests to determine the health of a web node, such as the application servers 214. Based on a JavaScript Object Notation (JSON) response received back from the application servers 214, the utility server 206 references a library of status codes and publishes HTML summary pages (linked back to the notifications 202) to help diagnose JVMs that may be in an unhealthy state. Examples of error codes may include the following: ERR100, Host Connect Error—indicating a JVM is shut down; ERR200, SSL Connect Error—indicating a JVM is down as a result a past effort to shut down or start up; ERR300, Monitor Time Out—time threshold (e.g., 10 seconds, or the like) was breached and monitor call has timed out; ERR400, Virtual Host Error—configuration or connectivity issue relating to application server; ERR500, Internal Server Error—usual web server error in which it's not able to route to any JVMs; ERR503, PegaRULES server not available—a JVM is active but data management platform engine failed to initialize; ERR600, Stream Node Error—the assigned Kafka process failed to join properly on the failing JVM; ERR700, Service Registry Error—node is not registered as part of hazel cast cluster; or ERR800, Stale Thread Errors—long running requestor or process has generated stale threads.

In this way, the present invention provides reusability, ease of configuration, one-touch initiation, validation, and notifications as a service to relevant users. In terms of reusability, collections of reusable shell scripts 212 that reside on the utility server 206 possess established integrations with application servers through SSH keys. In terms of ease of configuration, single point configuration files provides a JVM-per-line approach, providing key variables and grouping JVMs based on application, environment, and node type. Furthermore, a wrapper script 210 may be initiated via Truesight (BladeLogic), providing unique application or environment details targeting grouped JVMs that will stop and start in a specified sequential order based on a single click from a user. Validation is accomplished by utilizing data management platform ping REST services, providing a robust collection of validation tests with JSON output. Based on this output, the present invention includes a series of error codes and HTML pages to help locate solutions in common error situations. In terms of notifications, job initiation and completion is distributed via email to key support distribution groups. These emails will also provide a summary of JVM state, with key error codes for any JVMs that may require investigation.

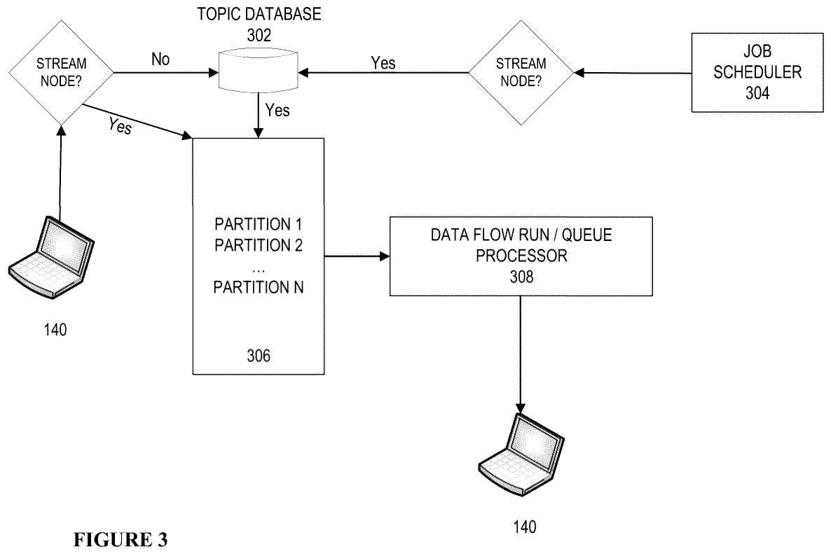

FIG. 3 illustrates a process flow for automated failure resolution in virtual machines, in accordance with an embodiment of the disclosure. As stated previously, the present invention provides one-click restart automation across both lower and production environments for various JVMs. This leads to consistent and predictable JVM outages, and leverages a ping REST API service for reliable, automated JVM health validation. The process is standardized, centralized, and updatable or upgradable over time. In addition, the process is also transparent, in that success or failure reporting with error codes is provided via detailed notification processing architecture. This offers a building-block for a “never-down” solution on conventional data management platforms, which is currently unavailable as a product. In terms of downtime of various JVMs, the time to repair a failure or return JVMs to a healthy, functional state is drastically reduced. For instance, shut down or start up of various applications is reduced by over 80% in some cases. In instances where downtime significantly affects an entity's ability to function, meet service level agreements, or earn revenue, this is a material improvement. This provides a simplified, efficient, and automated solution to produce consistent outage windows in addition to providing automated JVM health validation, standardized processes, and built-in success or failure reporting with specific error codes.

As shown in FIG. 2, certain application servers 214 may be assigned a sequential restart start up order as determined by their JVM type, as indicated by “1^{st}” alongside the stream JVM 218, “2^{nd}” alongside the batch group JVMs 220 and 22, and “3^{rd}” alongside the user group JVM. This is made possible by the specific job scheduling architecture outlined in FIG. 3, wherein one or more end-point device(s) 140 communicate with a topic database 302 in order to initiate a start up or shut down process and receive information from a data flow run/queue processor 308. As shown in FIG. 3, the job scheduler 304 may query whether a stream node is active, the status of which will be updated continuously in the topic database 302. The topic database, indicating active JVMs or nodes, may dictate which data partitions are shut down or started up in a sequential order, depending on JVM type. As indicated in block 306, this may include one or more partitions, including partition 1, partition 2, partition N, and so on. In some embodiments, the re-start sequence may vary based on the size of certain applications or nodes. For instance, with relatively large applications, an ideal re-start sequence may begin with stream JVMs, followed by batch group JVMs, and finally user group JVMs. In some embodiments, a shut down sequence of large applications may follow an exact opposite order. In some embodiments, small or medium size applications may require a re-start sequence of first stream JVMs, followed by batch group JVMs and user group JVMs together. In some embodiments, a shut down of small or medium applications sequence may follow an exact opposite order.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automated failure resolution in virtual machines, the system comprising:
at least one non-transitory storage device; and
at least one processor coupled to the at least one non-transitory storage device, wherein the at least one processor is configured to:
ping one or more virtual machines of a data management platform to request a status of operation of the one or more virtual machines;
receive status data from the one or more virtual machines;
apply a reusable script on the status data from the one or more virtual machines to generate a status notification;
automatically route the status notification to one or more end-point devices;
simultaneously, in conjunction with routing the status notification, publish HTML code representing the status data from the one or more virtual machines.

2. The system of claim 1, wherein status notification further comprises one or more error codes indicating specific issues with the one or more virtual machines, wherein the error codes comprise embedded links to the published HTML code representing the status data from the one or more virtual machines.

3. The system of claim 1, wherein pinging the one or more virtual machines of the data management platform further comprises using a representational state transfer (REST) application programming interface (API).

4. The system of claim 1, wherein the status data from the one or more virtual machines further comprises failure notifications including a host connect error, secure socket layer (SSL) connect error, monitor time out, virtual host error, internal server error, server not available error, stream node error, service registry error, or stale thread error.

5. The system of claim 1, further configured to: schedule a shutdown of a subset of the one or more virtual machines, wherein scheduling the shutdown comprises utilizing a job scheduler to determine a sequential order of shutdowns for the subset of the one or more virtual machines based on virtual machine type and application size.

6. The system of claim 5, wherein the virtual machine type comprises a streaming virtual machine, batch group virtual machine, or user group virtual machine.

7. The system of claim 1, further configured to: schedule a startup of a subset of the one or more virtual machines, wherein scheduling the startup comprises utilizing a job scheduler to determine a sequential order of startups for the subset of the one or more virtual machines based on virtual machine type and application size.

8. A computer program product for automated failure resolution in virtual machines, the computer program product comprising a non-transitory computer-readable medium comprising code causing an apparatus to:
ping one or more virtual machines of a data management platform to request a status of operation of the one or more virtual machines;
receive status data from the one or more virtual machines;
apply a reusable script on the status data from the one or more virtual machines to generate a status notification;
automatically route the status notification to one or more end-point devices;
simultaneously, in conjunction with routing the status notification, publish HTML, code representing the status data from the one or more virtual machines.

9. The computer program product of claim 8, wherein status notification further comprises one or more error codes indicating specific issues with the one or more virtual machines, wherein the error codes comprise embedded links to the published HTML code representing the status data from the one or more virtual machines.

10. The computer program product of claim 8, wherein pinging the one or more virtual machines of the data management platform further comprises using a representational state transfer (REST) application programming interface (API).

11. The computer program product of claim 8, wherein the status data from the one or more virtual machines further comprises failure notifications including a host connect error, secure socket layer (SSL) connect error, monitor time out, virtual host error, internal server error, server not available error, stream node error, service registry error, or stale thread error.

12. The computer program product of claim 8, further configured to: schedule a shutdown of a subset of the one or more virtual machines, wherein scheduling the shutdown comprises utilizing a job scheduler to determine a sequential order of shutdowns for the subset of the one or more virtual machines based on virtual machine type and application size.

13. The computer program product of claim 12, wherein the virtual machine type comprises a streaming virtual machine, batch group virtual machine, or user group virtual machine.

14. The computer program product of claim 8, further configured to: schedule a startup of a subset of the one or more virtual machines, wherein scheduling the startup comprises utilizing a job scheduler to determine a sequential order of startups for the subset of the one or more virtual machines based on virtual machine type and application size.

15. A method for automated failure resolution in virtual machines, the method comprising:
pinging one or more virtual machines of a data management platform to request a status of operation of the one or more virtual machines;
receiving status data from the one or more virtual machines;
applying a reusable script on the status data from the one or more virtual machines to generate a status notification;
automatically routing the status notification to one or more end-point devices;
simultaneously, in conjunction with routing the status notification, publishing HTML, code representing the status data from the one or more virtual machines.

16. The method of claim 15, wherein status notification further comprises one or more error codes indicating specific issues with the one or more virtual machines, wherein the error codes comprise embedded links to the published HTML code representing the status data from the one or more virtual machines.

17. The method of claim 15, wherein pinging the one or more virtual machines of the data management platform further comprises using a representational state transfer (REST) application programming interface (API).

18. The method of claim 15, wherein the status data from the one or more virtual machines further comprises failure notifications including a host connect error, secure socket layer (SSL) connect error, monitor time out, virtual host error, internal server error, server not available error, stream node error, service registry error, or stale thread error.

19. The method of claim 15, further comprising: scheduling a shutdown of a subset of the one or more virtual machines, wherein scheduling the shutdown comprises utilizing a job scheduler to determine a sequential order of shutdowns for the subset of the one or more virtual machines based on virtual machine type and application size.

20. The method of claim 15, further comprising: schedule a startup of a subset of the one or more virtual machines, wherein scheduling the startup comprises utilizing a job scheduler to determine a sequential order of startups for the subset of the one or more virtual machines based on virtual machine type and application size.
